(19) United States
(12) Patent Application Publication
(10) Pub. No.: US 2004/0043178 A1
(43) Pub. Date: Mar. 4, 2004

(54) Removable, repositionable, decorative design and method of manufacturing same

(76) Inventor: John R. Andrews, Wayne, PA (US)

Correspondence Address: CLIFFORD G. FRAYNE, Suite 7A, 136 Drum Point Road, Brick, NJ, 08723, US

(21) Appl. No.: 10/653,773

(22) Filed: Sep. 3, 2003

Related U.S. Application Data
(60) Provisional application No. 60/407,571, filed on Sep. 3, 2002.

(51) Int. Cl. B32B 9/00

(52) U.S. Cl. 428/40.1; 428/42.3

(57) ABSTRACT

A removable, reusable and repositionable decorative product having an image thereon for application to a wall or substrate, the decorative product having a vinyl or other plastic layer having a first side and a second side, there being positioned on the first side, a white raft layer overlaid with a design layer overlaid with a matting agent, there being positioned on the second side a non-migrating, repositionable adhesive layer overlaid with a silicone release layer overlaid with a removable support layer, the support layer being releasable with the silicone layer allowing the vinyl/plastic layer with overlying white raft layer and design and matte layer to be positioned on a wall or substrate by means of the non-migrating repositionable adhesive layer.

### RELATED APPLICATIONS

Applicant claims the benefit of provisional application Serial No. 60/407,571, filed Sep. 3, 2002.

### BACKGROUND OF THE INVENTION

1. Field of the Invention

The present invention relates to decorative products, and more particularly, to a preprinted reproduction of art work printed on a removable, repositionable adhesive backed clear, frosted or matte vinyl or any plastic sheet which allows for the placement, removal and replacement of the decorative work without leaving a residue or damaging the substrate.

2. Description of the Prior Art

The interior walls of a building, such as a home or an office, hotel, or restaurant are subject to the decorative whims of the owner, user, or occupier. A particular type of decoration often used is a wall border, which is a decorative strip positioned on a wall at the intersection of the wall and the ceiling, or in some instances, positioned on a wall about a window or a door frame or above a chair railing. These wall borders or strips are laborious to install and even more laborious to take down due to damage to the underlying substrate, be it paint or wallpaper. Further, they are difficult or impractical to change seasonally or for special occasions, and wall borders of the present art are usually nothing more than wallpaper type material affixed to the wall with an adhesive, hence the damage to the wall when one attempts to remove it.

It would therefore be advantageous to have a decorative product which could be positioned on the wall or substrate and be subject to being removed and repositioned without damage to the underlying wall or substrate and without the need for a separate adhesive in order to reposition or re-apply the decorative product.

The present invention because of very close die cutting and matte layer and clear carrier plastic layer resembles a professional, hand painted wall border on the wall. Still further, because of the non-migrating repositionable adhesive, the wall border can be easily installed, removed, repositioned or reinstalled. It may even be repositioned on its original backing for storage and reuse at a later time.

### OBJECTS OF THE INVENTION

An object of the present invention is to provide for a novel decorative product having a decorative image thereon which can be applied to a wall or substrate without any tools or chemicals.

A further object of the present invention is to provide for a novel decorative product with an image thereon which can be removed from the wall or substrate without leaving any residue or damaging the wall or substrate.

A still further object of the present invention is to provide for a novel decorative product with an image thereon which can be repositioned on the wall or substrate without any additional tools, chemicals or adhesive.

A still further object of the present invention is to provide for a novel decorative product on a clear or matte plastic to see the background color through the non-design areas so as to give the perception of a hand-painted design on the substrate surface.

A still further object of the present invention is to provide for a decorative product which can be easily removed from the wall or substrate without damage to same and be stored for reuse at a later time, thus permitting the user to install separate decorative product with different image in order to change the look or feel of the room on a seasonal or holiday basis.

### SUMMARY OF THE INVENTION

A removable, reusable and repositionable decorative product having an image thereon for application to a wall or substrate, the decorative product having a vinyl or other plastic layer having a first side and a second side, there being positioned on the first side, a white raft layer overlaid with a design layer overlaid with a matting agent, there being positioned on the second side a non-migrating, repositionable or ultra repositionable adhesive layer overlaid with a silicone release layer overlaid with a removable support layer, the support layer being releasable with the silicone layer allowing the vinyl/plastic layer with overlying white raft layer and design and matte layer to be positioned on a wall or substrate by means of the non-migrating repositionable adhesive layer.

### BRIEF DESCRIPTION OF THE DRAWINGS

These and other objects of the present invention will become apparent, particularly when taken in light of the following illustrations wherein:

FIG. 1 is a cross sectional view of the decorative product having an image thereon indicating the various layers; and

FIG. 2 is a top plan view of the decorative product of the present invention.

### DETAILED DESCRIPTION OF THE DRAWINGS

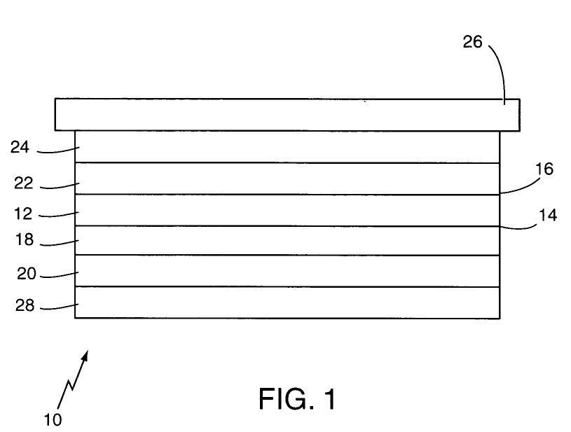

FIG. 1 is a cross sectional view of the repositionable decorative design of the present invention illustrating the layers of construction of the decorative design.

The decorative design member 10 comprises a vinyl layer 12 having a first side 14 and second side 16. On first side 12, there is applied a white raft layer 18 comprised of a white opaque pigment. The outline of the raft layer 18 is the same as the design layer 20 which is overlaid the white raft layer 18.

The design layer 20 overlays the white raft layer 18. A matte layer 28 overlays the design layer. The design layer 20 is a screen, flexographic letterpress or offset printed layer manufactured in hand painted art format which allows individual pieces to be applied in registration or entire sheets of multiple designs can be applied in registration repeatedly. Since the design layer 20 may or may not incorporate a design which encompasses the entire area of the vinyl or plastic layer 12, the color of the wall or substrate may appear through decorative design member 10 when the design layer 20 does not encompass the entire area of the vinyl or plastic layer 12. The combination of vinyl layer 12, white raft layer 16, design layer 20, and matte layer 28 gives the illusion of a hand painted border and the composition of the white raft layer 18 enhances the colors of the design layer 20 regardless of the various colored substrates to which it may be applied. The ink used in the screen or flexographic offset process is preferably a solvent based pigment, UV curable or water based ink.

There is applied to second side 16 of vinyl layer 12 an adhesive layer 22 which is overlaid with a silicone or separation layer 24 which is overlaid with a support or backing layer 26. The adhesive layer is a repositionable or ultra repositionable pressure sensitive adhesive composed of an acrylic formulation of polymers, tactifiers, resins and wetting agents, which provides for an adhesive layer when the support layer 26 is separated therefrom, and which will not migrate into the substrate against which it is positioned. As such, the decorative design member 10 can be applied to a substrate, removed from a substrate and reapplied to another substrate without damaging the substrate such as removing paint or wallpaper when the decorative design member is removed or alternatively leaving a layer or residue of adhesive on the substrate.

The support or backing layer 26 could be paper, polymer or the like. Its important feature is that it can be peeled away in conjunction with the silicone layer 24 to expose the adhesive layer 22 for positioning the decorative design member 10 on the desired substrate. The support or backing layer 26 may also be saved and reused to store the decorative product. As an example, a particular room could have a rather conservative wall border which could be removed, stored, and replaced for a period of time by a more lively or seasonal border, such as one having a Christmas theme or motif. This would have particular application and benefit to eating establishments and restaurants which often change interior decoration for the seasons and holidays. This would be an easy and inexpensive way to enhance and augment that decoration which is not labor intensive.

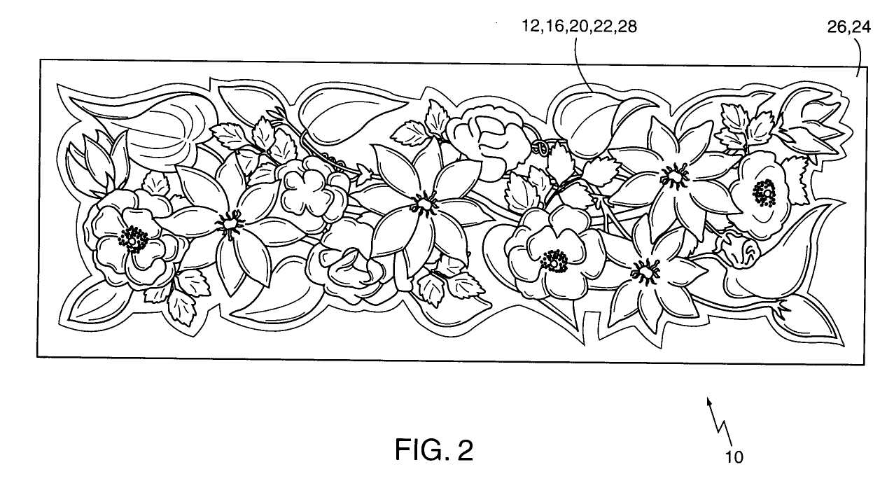

FIG. 2 is a top plan view of decorative design member 10 with a design. The vinyl or plastic layer 12, adhesive layer 22, white raft layer 16, design layer 20 and matte layer 28 are coextensive, that is that their peripheries are in alignment. The support or backing layer 26 and silicone layer 24 extend beyond the peripheries.

The decorative product of the present invention has been described in the embodiment of a wall border. In this embodiment the product would be fabricated in 18 inch strips, each strip having a repeated decorative design for ease of handling. However, it should be pointed out that the lamination protocol disclosed herein could also have application to other decorative products of a non-repeating design nature. For instance, the posters/murals decorating a child's or teenager's room could be fabricated with this lamination protocol to eliminate wall damage when one particular singing group falls out of favor and must be replaced with a poster of the new “hot” singing group.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A decorative design member having adherent qualities, yet removable and repositionable, said decorative design member comprising:
a support layer having a first side and a second side, said first side overlaid with a white raft layer, said white raft layer comprised of a white opaque pigment;
a design layer overlaid said white raft layer and in registration with said white raft layer;
a matte layer overlaid said design layer;
an adhesive layer overlaid said second side of said support layer in registration with said design layer and said white raft layer, said adhesive layer overlaid with a silicone separation layer, said silicone separation layer overlaid with a support backing layer wherein said adhesive layer comprises a repositionable or ultra repositionable pressure sensitive adhesive comprised of an acrylic formulation of polymers, tactifiers, resins and wetting agents, said adhesive layer non-migrative into a substrate against which it is positioned.

2. The decorative design member in accordance with claim 1 wherein said support layer is a water-pervious meta paper coated with a release layer.

3. The decorative design member in accordance with claim 1 wherein said support layer is a vinyl substrate.

4. The decorative design member in accordance with claim 1 wherein said design layer is a screen, flexographic or offset printed layer.

5. The decorative design member in accordance with claim 1 wherein said white raft layer comprises a white opaque pigment mixed with a clear solvent base and is applied in registration with the design layer.

6. A method of preparing a decorative design member having adherent qualities, yet removable and repositionable without leaving a residue or damaging the substrate to which it is applied, said method of preparing said decorative design member comprising:
a. positioning a support layer having a first side and a second side;
b. overlaying said first side of said support layer with a white raft layer, said white raft layer comprised of a white opaque pigment;
c. overlaying said white raft layer with a design layer, said design layer and said white raft layer in registration with each other;
d. overlaying said design layer with a matte layer;
e. overlaying said second side of said support layer with an adhesive layer in registration with said design layer and said white raft layer, said adhesive layer comprising a repositionable, pressure sensitive adhesive comprised of an acrylic formulation of polymers, tactifiers, resins, and wetting agents, said adhesive layer non-migrative into a substrate against which it is positioned; and
f. overlaying said adhesive layer with a silicone separation layer overlaid with a support backing layer.
